(19) United States
(12) Patent Application Publication
(10) Pub. No.: US 2005/0029356 A1
(43) Pub. Date: Feb. 10, 2005

(54) Scanner reader Active-X plug-in

(76) Inventors: Didier Frantz, New York, NY (US); Olivier Attia, New York, NY (US); Ashish Muni, Flushing, NY (US)

Correspondence Address: Avi Outmezguine, Fourth Floor, 54 West 39th Street, New York, NY, 10018, US

(21) Appl. No.: 10/892,853

(22) Filed: Jul. 16, 2004

Related U.S. Application Data
(60) Provisional application No. 60/492,306, filed on Aug. 5, 2003.

(51) Int. Cl. G06K 7/10; G06F 17/00; G06F 19/00

(52) U.S. Cl. 235/462.15

(57) ABSTRACT

The present invention enables the transfer of data from barcode scanners to computers for use with various software applications. An Active-X plug-in is downloaded to the user's computer the first time they access an application and need to use the scanner to upload information they have scanned using the barcode scanner. The Active-X plug-in aids the transfer and translation of data from the user's computer to the dedicated servers through the application. The Active-X plug-in is compiled code that resides on the user's machine making function calls to system files that interact with the barcode scanner by communicating with the machine's COM ports. Once the Active-X plug-in gathers the data from the scanner, the data can be used by the host application or posted to the Internet via XML.

### FIELD OF THE INVENTION

The present invention relates generally to the field of barcode scanner interface software. More specifically, the present invention describes an Active-X plug-in which simplifies the transfer of information from a barcode scanner to a computer.

### PARENT CASE TEXT

This application claims the benefit of provisional application No. 60/492,306 filed Aug. 5, 2003.

### BACKGROUND OF THE INVENTION

Transferring information from a barcode scanner to a computer is often a tedious, but necessary, process. The information is usually transferred by using a special cable to connect the barcode scanner to a port on the computer (e.g., a serial port, a USB port, a PS/2 port). The method of transferring the information from the barcode scanner to the computer depends mainly upon the scanner which is utilized. Many barcode scanners are configured to upload the scanned barcode information as a string of characters usually separated by a delimiter. In this scenario, the barcode scanner can usually be connected to the PS/2 or USB port of a computer. The barcode information is then transferred to the computer by simulating keyboard entry. Currently, this is the most common method of transferring barcode information to a computer.

In other instances, the barcode scanner uploads the barcode information to a computer and a software program located on the computer is responsible for converting the uploaded data to a usable format. The software program is usually a standalone application which acts as an interface between the barcode scanner and another software application which requires the scanned barcode information.

Based on the aforementioned described problems with mobile digital imaging, there clearly exists a need for a simple interface between a computer and a barcode scanner which automatically detects an attached scanner and facilitates simple uploading.

### SUMMARY OF THE INVENTION

The present invention is an Active-X plug-in designed to facilitate the transfer of information between a barcode scanner and an application on a computer. The Active-X plug-in can be used to interface with web-based applications or standard desktop software (through the use of modules supplied by the distributing company). In use, a user first accesses a specific application and the Active-X plug-in automatically downloads to the user's computer (depending on security settings—the user will be prompted to accept the Active-X plug-in). However, the Active-X plug-in may also available for manual installation for users with strict network security specifications.

Once the Active-X plug-in has been installed, the user simply attaches the barcode scanner to the computer utilizing the standard method of connection for the particular scanner. Most barcode scanners connect to a computer via a proprietary cable which interfaces with one of the computer's ports (e.g., RS-232, Serial, USB, parallel, etc.). The Active-X plug-in automatically detects any attached barcode scanners by constantly polling all available ports.

The user interacts with the application to upload the data from the scanner typically by choosing the scanner from an on-screen list and then clicking “Upload.” The Active-X plug-in can also be configured to automatically upload information from any attached barcode scanner. The uploaded data is then shown in a meaningful format to the user (on screen) and is available for use by the host application.

Therefore, it is an object of the present invention to provide an Active-X plug-in which facilitates the transfer of information from a barcode scanner to a host application located on a computer.

It is another object of the present invention to provide an Active-X plug-in which automatically downloads when a host application is launched.

An additional object of the present invention is to provide an Active-X plug-in that is capable of automatically recognizing a wide variety of barcode scanners.

Yet another object of the present invention is to provide an Active-X plug-in which can interface with barcode scanners connected to a variety of ports on a computer.

These and other objects of the present will be made clearer with reference to the following detailed description and accompanying drawings.

### BRIEF DESCRIPTION OF THE DRAWINGS

FIG. 1 depicts a flowchart showing the process utilized to install the Active-X plug-in.

FIG. 2 depicts a flowchart showing the process used to upload information from a barcode scanner to a host application.

### DETAILED DESCRIPTION OF THE PREFERRED EMBODIMENT(S)

The following presents a detailed description of a preferred embodiment (as well as some alternative embodiments) of the present invention. However, it should be apparent to one skilled in the art that the described embodiment may be modified in form and content to be optimized for a wide variety of situations.

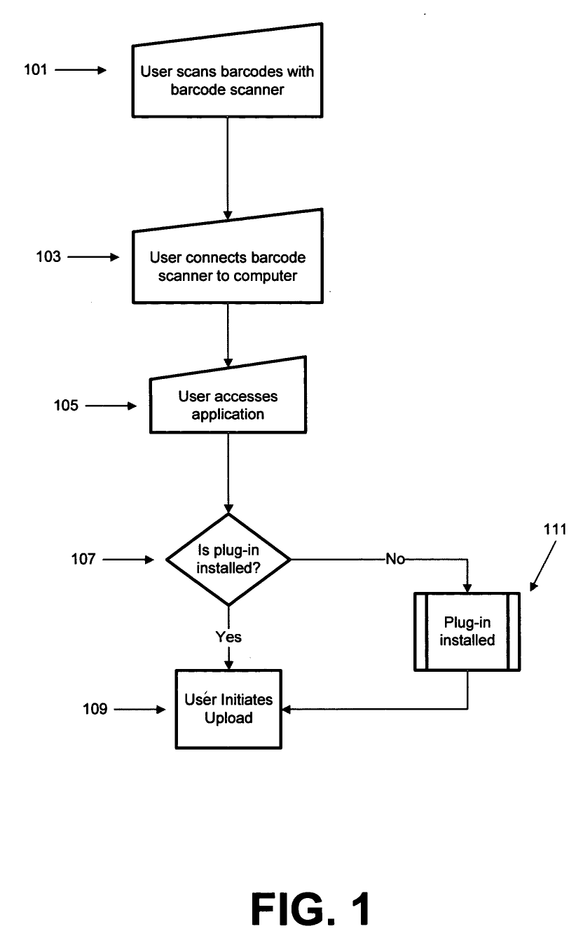

With reference first to FIG. 1, shown is a flowchart depicting the steps utilized to install the Active-X plug-in of the present invention. First, the user utilizes a barcode scanner to scan all of the desired barcodes in step 101. The barcode scanner may be any type of barcode scanner which is currently available. The most common type of barcode scanners are laser-based scanners. These scanners have the advantage that they can scan data very quickly. However, these types of scanners are usually only able to decode a few types of barcode formats.

Optical barcode scanners, such as are disclosed in co-pending U.S. patent application Ser. No. 10/757,095 entitled “System and method for decoding and analyzing barcodes using a mobile device” and U.S. patent application Ser. No. 10/796,153 entitled “System and method for decoding barcodes using digital imaging techniques,” have the advantage that their decoding is controlled by software. Thus, optical barcode scanners can be programmed to decode almost any type of barcode and can be updated to decode newer barcode formats. Some examples of commonly used barcode types include UPC-A, UPC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, and Data Matrix.

Once all the scans have been completed, the user connects the barcode scanner to the computer in step 103. The barcode scanner is typically attached to the computer via a proprietary wire which is used to connect the barcode scanner to one of the computer's various ports (e.g., a serial port, USB port, parallel port, etc.). The barcode scanner may even be connected to the computer using wireless means such as Bluetooth or a Wi-Fi connection. The user then launches the application on the computer which processes the scanned barcode information in step 105.

The host application then checks to see if the Active-X plug-in is installed in step 107. If the Active-X plug-in in is installed, the user may upload the scanned barcodes to the application in step 109. However, if the Active-X plug-in is not installed, the user is automatically prompted to install the Active-X plug-in from the Internet or to connect to the Internet so the Active-X plug-in can be downloaded and installed in step 111. Then, after the Active-X plug-in has been installed, the user can upload the scanned barcodes in step 109.

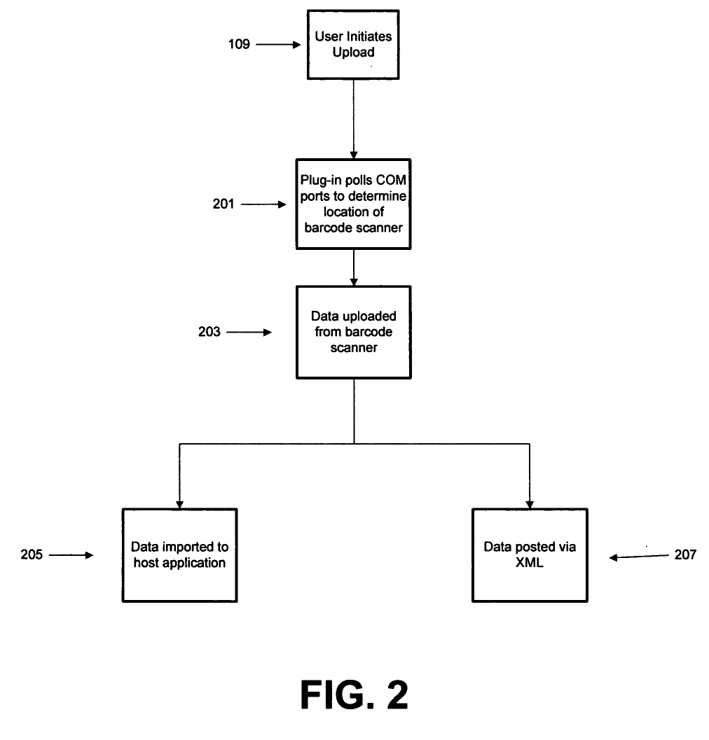

Now referring to FIG. 2, shown is a flowchart depicting the steps utilized by the Active-X plug-in to acquire data from the barcode scanner. After a user has selected to upload information from the barcode scanner to the computer in step 109, the Active-X plug-in polls all available communication ports and determines the location of the scanner in step 201. The Active-X plug-in may also access the system registry of the computer to help in determining the location of the barcode scanner.

Once the barcode scanner has been located by the Active-X plug-in, it uploads the data from the scanner in step 203. The Active-X plug-in is capable of accepting data in a variety of formats such as. The uploaded information can then be used by the host application in step 205 or posted to the internet via XML for use by an internet application in step 207.

While the foregoing embodiments of the invention have been set forth in considerable detail for the purposes of making a complete disclosure, it should be evident to one skilled in the art that multiple changes may be made to the aforementioned description without departing from the spirit of the invention.

1. An Active-X plug-in for uploading information from barcode scanners comprising:
a polling routine which constantly polls all available communication ports of the computer to determine if a barcode scanner is attached;
a detection engine to determine the type of said barcode scanner upon detection by said polling routine; and
an upload engine for transferring barcode information stored on said barcode scanner to said computer.

2. An Active-X plug-in according to claim 1, further comprising:
a translation engine for formatting said uploaded barcode information from said barcode scanner for use with a software application located on said computer.

3. An Active-X plug-in according to claim 1, further comprising:
a posting routine for transmitting said uploaded barcode information to a network location.

4. An Active-X plug-in according to claim 3, wherein said network location is a universal resource locator.

5. An Active-X plug-in according to claim 3, wherein said barcode information is transmitted via XML.

6. An Active-X plug-in according to claim 2, wherein said barcode information is converted to a character delimited format.

7. An Active-X plug-in according to claim 1, wherein said Active-X plug-in is automatically downloaded when the said barcode scanner is attached to said computer for the first time.

8. An Active-X plug-in according to claim 1, wherein said barcode scanner is a laser-based barcode scanner.

9. An Active-X plug-in according to claim 1, wherein said barcode scanner is attached to said computer via a proprietary wire.

10. An Active-X plug-in according to claim 1, wherein said barcode scanner is attached to said computer via at least one from the group consisting of a serial port, a USB port, a parallel port, a RS-232 port, a PS/2 port, and a Firewire port.

11. A process for uploading information from a barcode scanner to a computer comprising the steps of:
scanning at least one barcode with a barcode scanner;
connecting said barcode scanner to a computer;
detecting said barcode scanner attached to said computer via an Active-X plug-in installed on said computer, wherein said Active-X plug-in detects said barcode scanner by constantly polling all available ports of said computer; and
uploading said barcode information from said barcode scanner to said computer utilizing said Active-X plug-in.

12. A process for uploading information from a barcode scanner to a computer according to claim 11, further comprising the step of:
formatting said uploaded barcode information for use with a software application located on said computer.

13. A process for uploading information from a barcode scanner to a computer according to claim 11, wherein said step of uploading is initiated by a user of said computer.

14. A process for uploading information from a barcode scanner to a computer according to claim 11, wherein said step of uploading occurs automatically in response to the detection of said barcode scanner.
